(19) United States
(12) Patent Application Publication
(10) Pub. No.: US 2005/0253345 A1
(43) Pub. Date: Nov. 17, 2005

(54) Height adjustable support for semitrailers or the like

(75) Inventor: Reinhold Riedl, Miltenberg (DE)

Correspondence Address: BACHMAN & LAPOINTE, P.C., 900 CHAPEL STREET, SUITE 1201, NEW HAVEN, CT, 06510, US

(73) Assignee: Georg Fischer Verkehrstechnik GmbH

(21) Appl. No.: 11/113,580

(22) Filed: Apr. 22, 2005

(30) Foreign Application Priority Data
May 11, 2004 (DE) 10 2004 023 749.2

(51) Int. Cl. B60P 1/00; B60S 9/00; B60G 17/00

(52) U.S. Cl. 280/6.153

(57) ABSTRACT

A height-adjustable support 10 for semitrailers 11 having a stationary outer support tube body 12 and an inner support tube 13, which is arranged in a longitudinally displaceable manner therein. The outer support tube body 12 is of trough-shaped design, the outer support tube body 12 having a U-shaped region 25 and the open region of the U-shaped region 25 being closed with a rear wall 15 and therefore forming a guide channel for the inner support tube 13 guided therein.

### BACKGROUND OF THE INVENTION

The invention relates to a height-adjustable support for semitrailers. Such supports, usually provided in pairs, are arranged at the front region of the semitrailers.

A generic “trailer landing gear” S 2000 can be seen in the brochure 098060 from haacon, D-97896 Freudenberg.

In this case, the outer support tube body, in which the inner support tube of square cross section is guided and supported, comprises a cross-sectionally U-shaped longitudinal profile, the limb end sides of which are welded to a continuous screw-on plate, which is of approximately the same length and protrudes on both sides.

In this design, the bending forces which arise and, in particular, the enormous shearing forces which occur during removal of the supporting load have to be transmitted, virtually exclusively in the force flux via the weld seams, first of all into the screw-on plate before being conducted via the screw connection into the chassis of the semitrailer. So that the necessary and recommended buckling strength is achieved, the weld joint has to be realized by means of weld seams which are of appropriately strong dimensions and are load-bearing over metre lengths, which necessitates a high production outlay which is demanding in terms of the welding technique.

On both sides of the vertical edge regions of the screw-on plate, this disconnecting support has a respective row of holes for the individual fastening in terms of height. Each of the rows of holes therefore has more than double the number of screw holes required for the actual fastening, with the result that more than half of all of the holes below and/or above the fastening screws placed during the assembly are unused, i.e. remain free, and, in addition to the thick weld seams which are visually conspicuous on the front side, the support exterior is also negatively influenced.

The invention is based on the object of providing a support for semitrailers having an outer support tube body which, as far as possible, has no load-bearing weld seams and which is optimal in terms of construction and costs and in design.

### SUMMARY OF THE INVENTION

In accordance with the present invention, the outer support tube body is produced from a trough-shaped profile, i.e. a U-profile, on the limb ends of which flange limbs which are integrally at right angles and protrude outward and are parallel to the U-back. And only the opening of the trough-type profile between the protruding flange limbs has to be closed, preferably by a welding technique, with a vertically continuous rear wall plate, thus producing a guide shaft for the inner support tube, which can preferably be produced from a commercially available square tube.

The particular advantage of the resultant statics is that the trough-type profile, as an integral load-bearing part, absorbs the main part of all of the abovementioned stresses and no longer conducts the forces in an initially unfavourable manner via the weld seams into the screw-on plate, but rather conducts them directly into the semitrailer frame by means of the screw connection. This means that weld seams, which are subject to less stress and are therefore thin, are acquired in order to attach the rear wall and, moreover, they cannot be seen after the attachment of the support.

Another feature of the invention is not to expose the screw holes during production, but rather, expressed symbolically, only to perforate them, so that only when the support is attached they are broken out or knocked out, depending on the requirement, i.e. of the arrangement in terms of height of the pattern of holes in an interface connected to the chassis of the semitrailer, in order to be able to introduce the fastening screws. For the purpose of subsequent exposure of the screw holes, the edges thereof are to be cut in by punching but not all the way through during the production of the outer support tube body, which should expediently take place from the rear side in terms of the attachment. This method provides great flexibility with regard to an individual fastening of the support without free, i.e. unused, holes having to be seen in the flange limbs afterwards.

The use of a trough-type profile affords further structural advantages. Thus, for example, part of the rear wall, as seen in the vertical longitudinal section, can be bent to the rear in the upper end region of the outer support tube body in such a manner that a cross-sectional enlargement is produced there above the preferably square guide channel, which enlargement can prove advantageous during the installation of the gear parts.

Or, it is possible, in the case of an economically reduced wall thickness of the trough-type profile, for corner beads to be impressed, for example at the two transitions of the said trough-type profile from the U-limbs to the flange limbs, which brings about stiffening with optimum use of the material.

### BRIEF DESCRIPTION OF THE DRAWINGS

The invention is explained below with reference to the drawings, in which:

FIG. 1 shows a front view of the support according to the invention,

FIG. 2 shows a side view of the support shown in FIG. 1,

FIG. 3 shows a section along the line A-A in FIG. 1,

FIG. 4 shows a section analogous to FIG. 3 of a conventional support,

FIG. 5 shows a front view of the support according to the invention as in FIG. 1, but, by way of example, attached lower down, and

FIG. 6 shows a section along the line B-B in FIG. 1.

### DETAILED DESCRIPTION

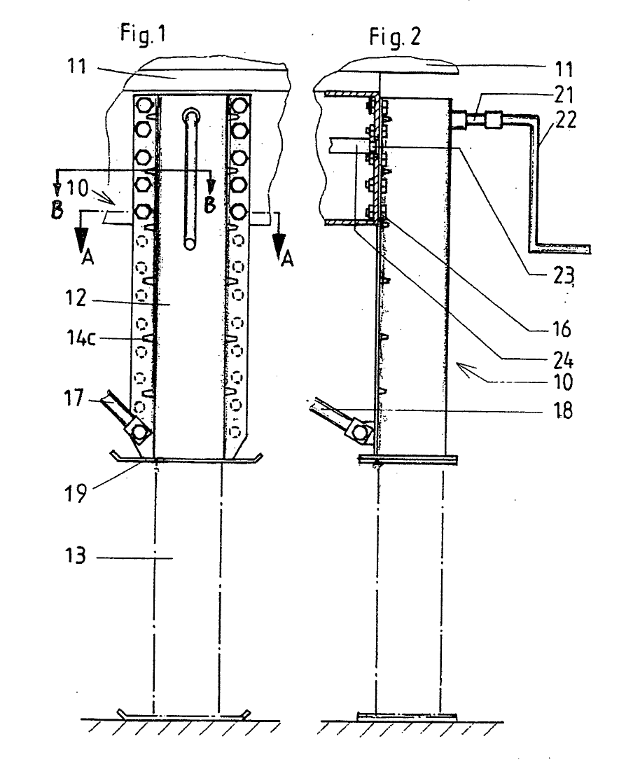

The support 10 shown in FIGS. 1 to 3 and FIGS. 5 and 6 is attached in a paired arrangement to the chassis of a semitrailer 11, in the front region thereof, and is retracted, i.e. is in the shortened state, in the transporting position. The supports 10 are extended before the semitrailer 11 is uncoupled from the articulated lorry.

Since the supports 10 of each pair are of identical construction, only one support 10 is described.

The support 10 has an outer support tube body 12 and an inner support tube 13, which is mounted in a longitudinally displaceable manner therein.

The outer support tube body 12 comprises a trough-type profile 14 comprising a U-shaped region having a U-back 14d, limbs 14e, with opposite flange limbs 14a at the limb ends and a rear wall 15 which is welded to the trough-type profile 14, so that there is a cross-sectionally square guide channel therein, into which the likewise square inner support tube 13 is mounted with a certain amount of play. And the trough-type profile 14 is provided with vertically spaced apart corner beads 14c for stiffening purposes.

There is a vertical row of holes in each case with screw holes 14b precut in it by punching in the flange limbs 14a.

The support 10 is fastened to the semitrailer 11 via the flange limbs 14a of its outer support tube body 12 by means of screws 16 and is braced by longitudinal and transverse struts 17, 18.

A foot 19 is fastened to the lower end of the inner support tube 13 for support on the ground.

In this exemplary embodiment of the invention, a spindle drive with a spindle 20 is installed in the support 10 and is used to adjust the inner support tube 13 or to raise or lower the load.

For this purpose, a gear, which has, inter alia, a drive shaft 21, is installed in the support 10 above the spindle 20, sits on a hand crank 22 and has an output shaft 23, via which the support arranged opposite is also driven by means of a connecting shaft 24.

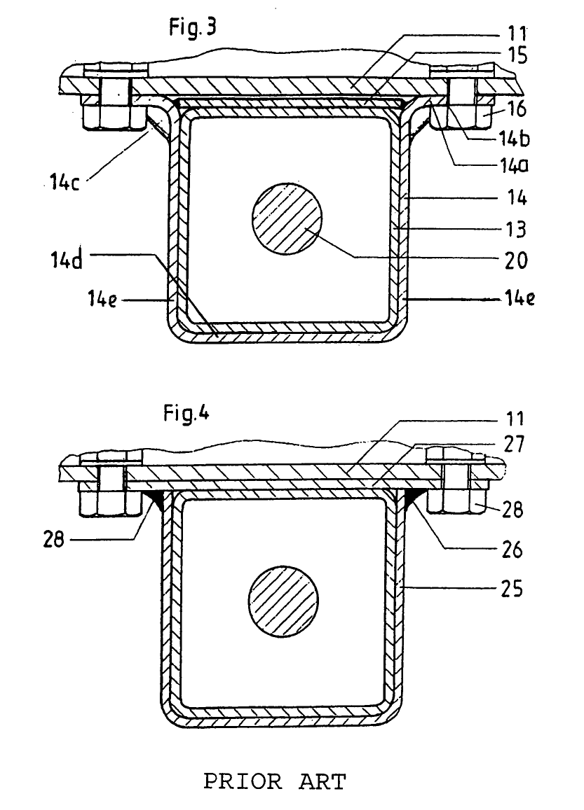

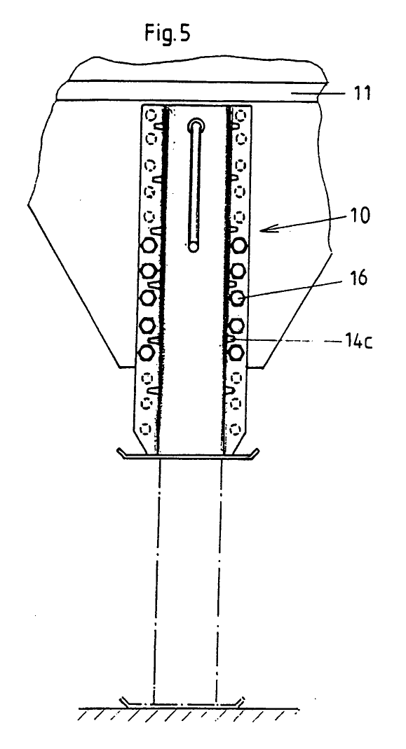

FIG. 4 shows, by way of a comparison, a section analogous to FIG. 3 through a support according to the brochure mentioned at the beginning, which section visually clarifies the unfavourable configuration, which has already been described, of this support.

The U-profile 25 is welded onto the screw-on plate 27 by strong, load-bearing weld seams 26 which are situated under high stress in the full force flux and have to absorb all of the forces. And only via the screw-on plate 27 are the forces introduced, by means of the screws 28, into the chassis of the semitrailer 11.

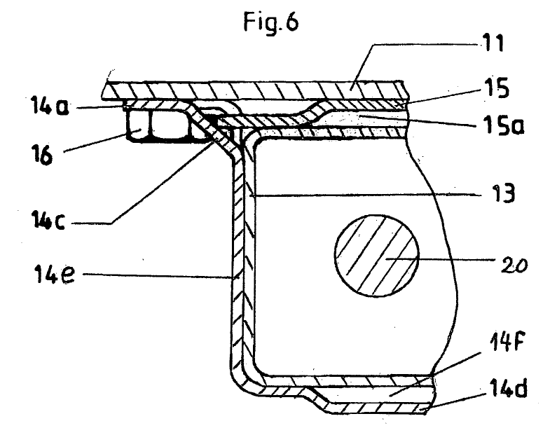

FIG. 6 shows a section of the support of FIG. 1, taken along a line B-B, i.e. in a higher region of the support than in FIG. 3. Here it can be seen that the U-back 14d has a recess 14f and that the rear wall 15 has a further recess 15a. These recesses 14f, 15a are made by stamping. By the configuration of the recesses 14f, 15a the walls of the support are locally reinforced and extra space is created for a drive motor and a gear.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

1. A height-adjustable support comprising a stationary outer support tube body and an inner support tube arranged in a longitudinally displaceable manner in the outer support tube body and is moved up or down therein by a driving mechanism, the outer support tube body (12) comprises a profile (14) having a U-shaped region having a U-back (14d), limbs (14e) with limb ends and, at the limb ends, outwardly projecting flange limbs (14a) which run parallel to the U-back, wherein the profile is closed between the flange limbs (14a) by a vertically extending continuous rear wall (15) to form a guide channel for the inner support tube (13).

2. Support according to claim 1, wherein the profile (14) is a pressed part.

3. Support according to claim 1, wherein in an upper region of the outer support tube body (12) a part of the rear wall (15) is bent outwards wherein a cross-sectional expansion of the outer support tube body (12) is formed.

4. Support according to claim 1, wherein the profile (14) has a recess (14f) formed by stamping.

5. Support according to claim 1, wherein the rear wall (15) has a further recess (15a) formed by stamping.

6. Support according to claim 1, wherein at edges of the profile (14) which are adjacent to the flange limbs (14a) there are provided corner beads (14c) for stiffening purposes.

7. Support according to claim 1, wherein a vertically running row of screw holes (14b) is located in the flange limbs (14a) of the profile (14).

8. Support according to claim 6, wherein an area in a zone of the screw holes (14b) is premachined to allow removal of material so the screw holes (14b) are produced.

9. Support according to claim 7, wherein edges of the screw holes (14b) are cut in by punching to form cutting slugs which can easily be broken off or knocked out to expose the screw holes (14b).
